(19) United States
(12) Patent Application Publication
(10) Pub. No.: US 2009/0072444 A1
(43) Pub. Date: Mar. 19, 2009

(54) Method of Producing a Building Decoration Material

(76) Inventor: XiaoLing Leng, Shanghai (CN)

Correspondence Address: Global Control Center Limited, 6256 Spring Mountain Raod., Ste 100-A, Las Vegas, NV, 89146, US

(21) Appl. No.: 12/087,347

(22) PCT Filed: Jan. 5, 2006
(86) PCT No.: PCT/GB2006/000029

§ 371 Date: Jun. 27, 2008

(51) Int. Cl. B29C 39/10

(52) U.S. Cl. 264/319

(57) ABSTRACT

This invention relates to a method for producing a building decoration material composite of liquid resin. By adding chemical additives to the mixed liquid resin and after heating and chemical reaction, and then solidify the on-process material, and again apply heating and then polished to be shaped. This method could be adopted to ensure the building decoration material for prevention of water and fire, minimizing the destruction and deterioration of material. The building material could be used to make toiletries kitchenware; craft gift and general merchandise etc.

This invention relates to a method for producing a resin-inlayed building decoration material. By adding chemical additives to the mixed liquid resin and after chemical reaction by heating, and then solidify the on-process material, and again apply heating and then polished to be shaped. This method could be adopted to ensure the building decoration material for prevention of water, minimizing the destruction and deterioration of material. The building decoration material could be used to make toiletries, kitchenware, craft gift and general merchandise, etc.

The building decoration material has the features such as prevention of water, minimizing the destruction and deterioration of material. This type of material could be adopted by users or designers to make any products they like. Since the material could prevent water, it could be adopted in all kinds of toiletries, kitchenware main material.

The main object of this invention is to provide a better material for making our final product for the public, and the product has the features of prevention of water, minimizing the destruction and deterioration of material.

Accordingly, this invention provides a better material for making the products of toiletries, kitchenware, craft gift and general merchandise, etc., easier, more convenient, environment protective and beautiful than the technics made by other materials. The product could be used a longer time and reduce the deterioration to keep the long-term freshment of the product.

Generally, natural marine accouterments can be used as the subassembly for making the resin-inlayed product, in which the liquid resin occupies 80% of the weight, while other types of materials occupy the rest 20%. The material used for this invention is various kinds of paper with printed pictures. By applying heating to the paper and then adding chemical additives to form a sheeny protecting film, and then put the on-process paper into the mould which filled with liquid resin, and the special function of using the so produced material in all kinds of products is to make the products more beautiful and to make the designed pictures more exquisite.

A preferred embodiment of the invention now be described with reference to the accompanying drawing in which:

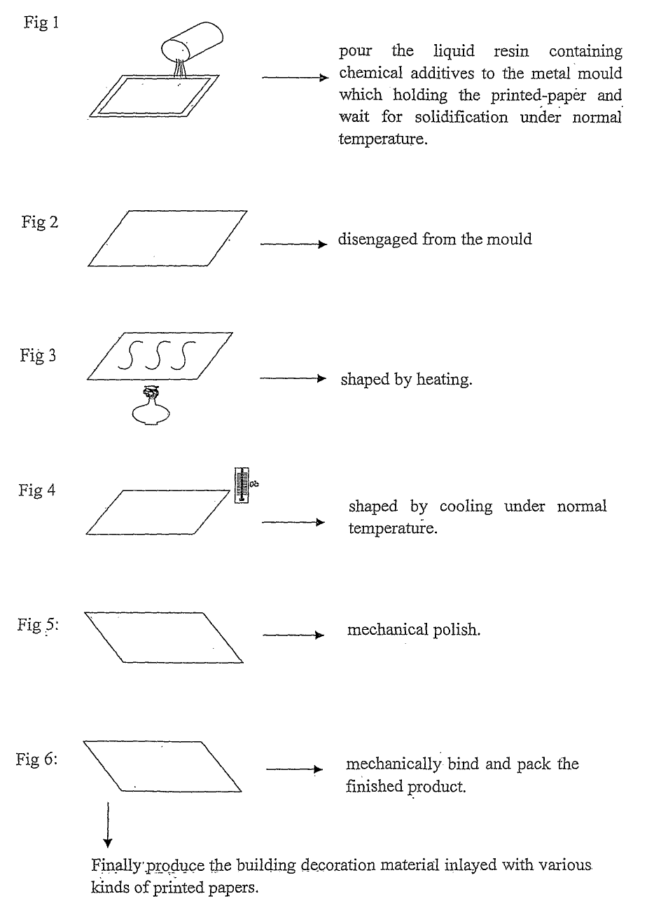

FIG. 1 shows the first stage of material preparation—pour the liquid resin containing chemical additives to the metal mould which holding the printed-paper and wait for solidification under normal temperature.

FIG. 2 shows the second stage of material preparation—disengaged from the mould.

FIG. 3 shows the third stage of material preparation—shaped by heating.

FIG. 4 shows the fourth stage of material preparation—shaped by cooling under normal temperature.

FIG. 5 shows the fifth stage of material preparation—mechanical polish.

FIG. 6 shows the finished product bound and packed mechanically. And finally produce the building decoration material inlayed with various kinds of printed papers.

For example, this material is similar to wood board, however, it is especially rigid and insulating as to be a good material to be used by the designers to produce useful products. A toilet board made from this material by a designer could prevent water, minimize the material destruction and deterioration in a long term, and make the toilet more beautiful than the others made from other materials.

1. A method of producing a building decoration material composite of liquid resin material.

2. The material is composed of as claim 1 by adding chemical additives, and then heating and solidifying and polished for two times to be shaped.

3. The method as herein described above and illustrated in the accompanying drawings.
